(19) United States
(12) Patent Application Publication
(10) Pub. No.: US 2011/0296111 A1
(43) Pub. Date: Dec. 1, 2011

(54) INTERFACE FOR ACCESSING AND MANIPULATING DATA

(76) Inventors: Rex Monty di Bona, Dural (AU); Karen Tan, Dural (AU)

(21) Appl. No.: 13/114,786

(22) Filed: May 24, 2011

(30) Foreign Application Priority Data
May 25, 2010 (AU) 2010902271

(51) Int. Cl. G06F 12/08

(52) U.S. Cl. 711/118; 711/E12.017

(57) ABSTRACT

A system and method for an interface for accessing and manipulating data to allow access to data on a storage module on a network based system. The data is presented as a virtual disk for the local system through a hardware interface that emulates a disk interface. The system and method incorporates features to improve the retrieval and storage performance of frequently access data such as partition information, operating system files, or file system related information through the use of local caching and difference calculations. This system and method may be used to replace some, or all, of the fixed storage in a device. The system and method may provide both online and offline access to the data.

### BACKGROUND OF THE INVENTION

This invention relates to a system for accessing and manipulating data, and particularly, although not exclusively, to a system for efficiently accessing and manipulating data on a data storage module over a network.

Computing and electronic devices such as computers, smart phones or electronic equipment may incorporate a storage device arranged to store data necessary to operate the device or data collected as part of the operation of the device. In many instances, these storage units may include hard disks, flash memory or ROM to store operating instructions or data for the computing or electronic device.

As these storage units are built into the computing or electronic device, these storage units may be inadvertently lost or damaged if the device itself is also lost or damaged. As such, the data stored therein may also be lost and may cause unnecessary distress or economic loss for users. As such, it is desirable in some instances for a computing and electronic device to be able to access a remote data storage facility so as to distribute data away from the operating environment of the device to minimise the risk of data loss.

Remote access between computing devices is typically performed using the Transmission Control Protocol/Internet Protocol (TCP/IP) suite of protocols, which is available over a wide variety of methods; wired connections, such as Ethernet, or wireless such as wireless networks (usually IEEE 802.11a/b/g/n or later standards) or over cellular phone networks. These protocols allow robust communications between a local device and a remote device.

Local access to storage devices is performed using a number of well defined standards, such as Small Computer Systems Interface (SCSI), Serial AT Attached (SATA), or to the various Digital Media Card standards such as Secure Digital (SD), Compact Flash (CF), Memory Stick (MS), or xD Picture card (xD). These standards are all block based standards, and access data in discrete block based chunks.

The local storage device incorporated into electronic devices usually stores data according to a layout called a file system. Most computing systems utilise the leading section of the disk for storage of frequently accessed file system meta-data, as well as partition information, and operating system boot information.

In the art there are various devices that attempt to convert between local block based access and remote storage. However these devices all provide a naïve interfacing with the remote facility and involve unnecessary data movement, or attempt to provide translation between different representations of the data.

U.S. Pat. No. 7,191,261 to Morgan describes an adapter to allow communication between a secure diskless computer and a remote network based storage. This design specifically excludes a cache for security reasons, and suffers the performance drawbacks entailed. Also, this patent states that the adapter is embedded with a signature specific to OS booting, rather than the more general approach we adopt.

U.S. Pat. No. 6,405,278 to Liepe describes a flash card comprising flash memory and an RF transmitter to allow data stored within the flash memory to be transferred to and from an extended storage device. The design does not address individual blocks of data, but rather the contents of the card at a time to avoid replacement of the card. Also, the RF transmitter is designed for close proximity transfers with the extended storage device being used as a proxy for more remote access, rather than utilising the ubiquity of IP based data transfers.

### BRIEF SUMMARY OF THE INVENTION

As presented the invention is used to transfer data between the local system and a remote storage. In one example, an embodiment of the invention is advantageous in that the interface for accessing and manipulating data can be directly installed into a computing device such as standard Personal Computers, Servers, portable computing devices, electronic devices or smart phones by replacement of the existing disk or memory storage unit within the computing device with an embodiment of the interface. In this embodiment, the interface is arranged to communicate with the disk controller of the computing device such that the computing device can perform storage operations via the disk controller as if the existing disk or memory storage module is present in the system whilst allowing the interface to access and manipulate data on one or more storage modules. The interface may be physically sized to a specific form factor for installation within the computing device. For example, the interface may be dimensioned to be installed within a 3.5 inch disk drive slot of a server, or dimensioned to fit within a Compact Flash memory slot on a digital camera.

This embodiment therefore provides an advantage in that a user can continue to use the computing device without any modification or adjustments whilst allowing data necessary for any operation to be stored remotely from the computing device itself.

In a further embodiment the interface utilises the provided cache in three separate section. Each section may be configured to a different portion of the local cache. These sections provide for the guaranteed caching of the first number of sectors of the remote virtual disk, the guaranteed caching of the first number of sectors accessed outside the area defined above, and then general caching of any remaining sectors.

The cache is used to provide improved access to the data on the virtual disk. The embodiment holds the first set of sectors from the virtual disk which usually holds partitioning information, operating system files, and file system meta-data. This improves access time to this often manipulated data.

In a further embodiment the interface will only perform a network write operation to the remote storage module when data has changed in the local cache.

In a further embodiment the interface includes a local hard disk drive that is used to cache data. This hard drive is accessed through a standard drive interface.

In a further embodiment the interface includes a non-volatile memory based device that is used to cache data. This non-volatile memory based device is accessed through a standard interface.

In a further embodiment the interface is tightly integrated with the internal electronics of a disk drive, such that the interface is used to drive the disk drive directly rather than through an open interface.

In a further embodiment the interface is tightly integrated with the internal electronics of a non-volatile memory based device, such that the interface is used to drive the non-volatile memory based device directly rather than through an open interface.

In a further embodiment the local cache holds a complete copy of all data stored in the virtual disk. The local cache also stores meta-data about each chunk of data, including but not limited to access information.

In a further embodiment the meta-data is updated to reflect write access that are not able to be transmitted to the remote storage module due to network or other failures.

In a further embodiment the interface updates the remote storage module when network communication is again possible.

In a further embodiment the interface uses the data and meta-data to determine the difference between the data in the local cache and the data in the remote storage module. The interface only transmits the differences between the local data and the remote data.

### BRIEF DESCRIPTION OF THE DRAWINGS

FIG. 1 is a block diagram of an example of a computing device with an interface for accessing and manipulating data in accordance with one embodiment of the present invention.

FIG. 2 is a block diagram of the interface for accessing and manipulating data of FIG. 1.

FIG. 3 is a block diagram of the interface for accessing and manipulating data in accordance with another embodiment of the present invention.

FIG. 4 is a wiring block diagram of the interface for accessing and manipulating of FIG. 3.

FIG. 5 is a block diagram of SATA Drive ASIC in accordance with one embodiment of the present invention.

FIG. 6 is a flow diagram of the initialisation process of the interface of FIG. 4.

FIG. 7 is a flow diagram of the clock thread of the interface of FIG. 4.

FIG. 8 is a flow diagram of the Z Cache thread of the interface of FIG. 4.

FIG. 9 is a flow diagram of the Drive Interface thread of the interface of FIG. 4.

FIG. 10 is a flow diagram of the Network thread of the interface of FIG. 4.

### DETAILED DESCRIPTION OF THE PREFERRED EMBODIMENT

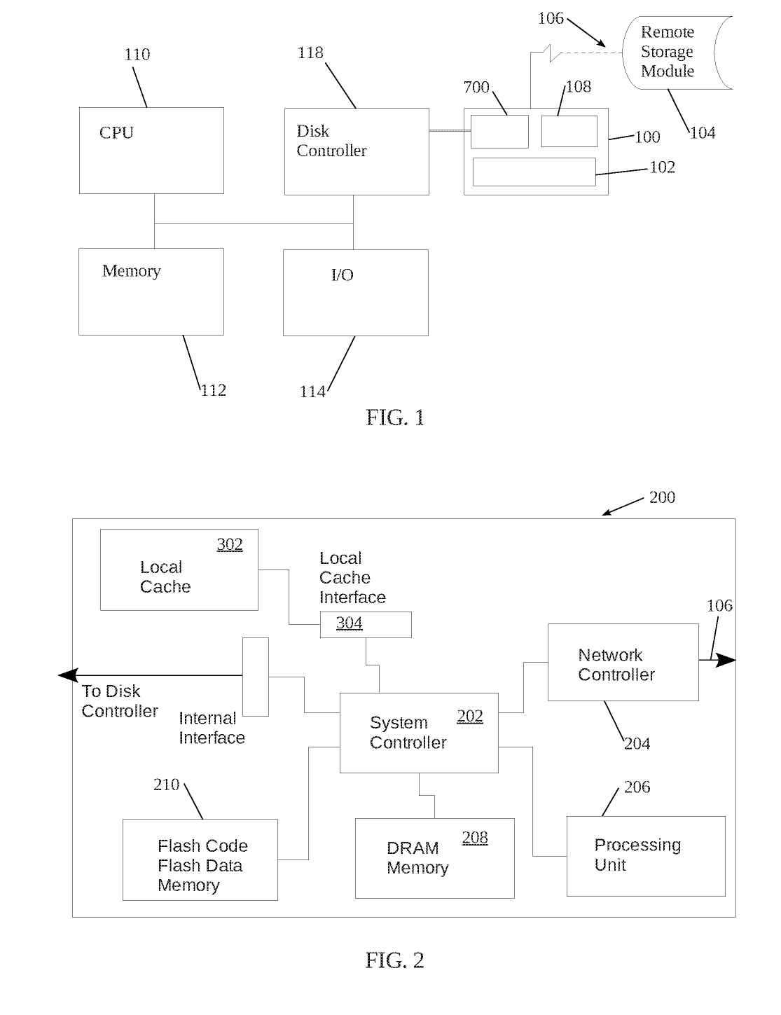

Referring to FIG. 1, there is provided an embodiment of an interface for accessing and manipulating data 100 comprising: a network module 102 arranged to communicate data with at least one storage module 104 via a network 106; and, a system module 108 arranged to access and manipulate the data on the at least one storage module 104 by controlling the communication of data by the network controller 102 to the at least one storage module 104.

In this embodiment, the interface 100 is arranged to be installed within a computing or electronic device, such as a general purpose computer, mainframe server, portable computer, mobile computing devices such as PDAs, Smart phones, mobile phones etc, or micro computing devices such as computing devices found in other mechanical or electrical units such as robots, vehicles, boats, aircraft, general appliances, factory equipment or medical devices etc. The interface 100 may be installed within a computing or electronic device by being connected to a storage interface 118, such as a disk controller 118 which communicates with the CPU 110, Memory 112 and Input/Output 114 devices of the computer via a system bus 116. In some examples, the interface 100 is implemented to replace an existing hard disk drive within a computing device such that instructions from the computing device to access and manipulate data on a storage device is processed by the interface 100 to access and manipulate data on a storage module 104 via a communication network 106.

With reference to FIG. 2, there is illustrated a first embodiment of the interface for accessing and manipulating data 200. In this embodiment, the interface 200 includes a system module, labelled as a system controller 202 arranged to control and instruct a network module, labelled as a network controller 204 to communicate data over a network 106 to one or more network storage modules 104 for accessing and manipulating data on the one or more network storage modules 104. The system controller 202 includes:
a processing unit 206 arranged to process data access and manipulation instructions received from the disk controller 118; and
a memory module 208 such as a DRAM Memory module to store instructions to be processed, data received from the network controller 202 or act as a work buffer for the processing unit 206.

In this embodiment, the system controller 202 also has a flash memory module 210 which may be a non-volatile memory module arranged to store firmware or operating routines for initiating and operating the interface 200.

The system controller 202 may be arranged to instruct and control the network controller 204 to transmit specific requests to access or manipulate data located on a networked storage device 104. In operation, where a user requests a specific piece of data (e.g. a specific piece of data which may form part of a file being used by a user) through the Input/Output device 114 of the computing device. In this example, the operating system of the computing device translates this request to the disk controller 118 via the system bus to instruct the disk controller 118 to retrieve this piece of requested data. Once the disk controller receives this request, the disk controller 118 instructs the interface 200 to retrieve this piece of data.

Once the interface 200 receives this request, the system controller executes a thread to identify the one or more storage modules 104 of this piece of data. After the identity of the one or more storage modules 104 are found, the system controller 202 then ascertains the network location of this storage module 104 such that an access instruction can be transmitted via the network controller 204.

In this embodiment, the network location of the one or more storage module 104 may include one or more IP addresses of one or more network storage devices, such as a network disk server or a remote server farm operating on any one of various disk access protocols (such as iSCSI, Fibre Channel over Ethernet, ATA over Ethernet etc). Once the network location is identified, the system controller 202 generates an instruction for this storage device 104 to read or write data on a specific track, sector, or block of the storage module 104. The instruction is then transmitted to the storage module 104 by the network controller 204.

Once transmitted by the network controller 204, the network controller 204 expects a reply from the storage module 104 with the data it has requested. The data, once received over the network 106 by the network controller 204 is then processed by the system controller 202 to a format suitable to be transmitted to the disk controller 118. For example, the network controller 204 may provide the data requested to the system controller 202 at the data link layer. This data is then transformed by the system controller 204 to a more lexical format for the disk controller 118.

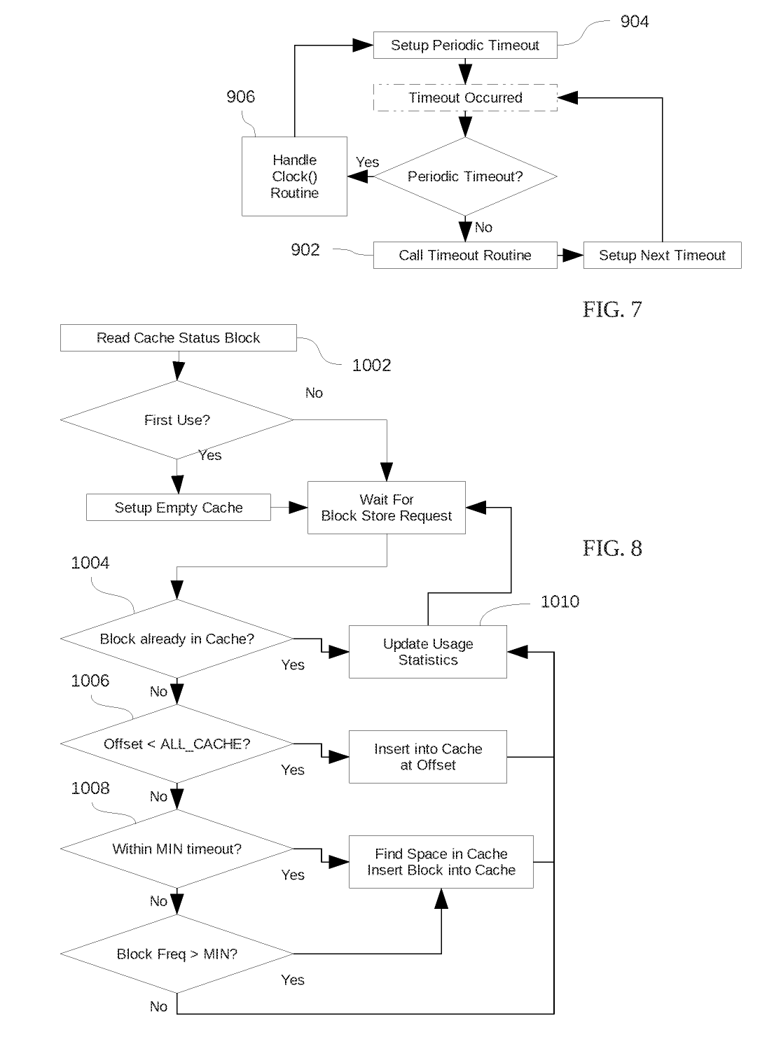

In some embodiments, the disk controller 118 may be interfaced to the system controller 202 through an internal interface 212 to allow communication between the system controller 202 and the disk controller 118. An example of this internal interface may include a SATA Driver ASIC (Application Specific Integrated Circuit) which is described in detail with reference to FIG. 7. Once the disk controller 118 receives the data from the system controller 202, the disk controller 204 then communicates with the CPU 110 of the computing device via the system bus 116 and provide the requested data to the computing device for further processing. In instances where the data cannot be retrieved, an error is reported by the disk controller 118 to the computing device. This error is subsequently communicated to the user via the input/output device 114 of the computing/electronic device.

In a preferred embodiment, the network controller 204 is arranged to facilitate communications over an Ethernet/Internet network 106. The network controller 204 transforms data access and manipulation instructions from the system controller 202 into data which are in a data link layer format or a physical layer format before transmission over the computer network. In some examples, the network controller includes a Physical Layer Transceiver (PHY) arranged to process data received from the system controller 202 into physical signals for transmission over the network 106.

In other embodiments, the network controller 204 is arranged to communicate over another form of data or communication network 106. For example, the network controller 204 can be arranged to communicate over a telecommunications link such as a mobile phone network, or a satellite communications link. The network controller 204 may also be arranged to communicate over a USB or Bluetooth connection. In these instances, the network controller may include a different type of Physical Layer Transceiver arranged to operate on the specific type of network in which the network controller 204 communicates over. For examples, the Physical Layer Transceiver may be arranged to communicate physical signals over a USB link if the interface 100, 200 operates on a USB connection.

Embodiments of the present invention are advantageous in that the interface for accessing and manipulating data 100, 200 allow a user to store and access data remote from the user's computing or electronic device over a communication network. Such an arrangement provides a first advantage in that data used or generated by the computing or electronic device is stored away from the device such that it may be individual backed up or secured from loss should the device be damaged or lost. An example of this interface 100, 200 and its advantages may reside in consumer electronic devices, such as Smart phones, digital cameras or portal computers. In these examples, users of these electronic devices may be able to directly store all generated data (e.g. word processor files, emails, photographs etc) in one or more data storage modules such as an office or home server whilst ensuring that in the event that the device is lost, stolen or damaged, the data is retained in the office or home server.

Another advantage of the embodiments of the present invention includes the allowance of a user of a computing device to centralise maintenance of software for each computing devices. For example, in large corporations where there are a large number of computers, each computer may require regular updates to its firmware, operating system and applications to ensure each computer operates at an optimal level. In these instances, each computer must undergo its own individual update, which increases the cost and time required to update each computer. However, where the computing devices use an embodiment of the interface 100, 200, then each computing device accesses one centralised copy of firmware, operating system or application, and thereby reduces the time, resource and effort required to update each computing device since only one centralised version of each of the firmware, operating system and application needs to be updated.

With reference to FIG. 2, there is shown another embodiment of the present invention. The interface for accessing and manipulating data 200 further includes a local cache 302, which in this example is a local flash memory module. The local flash memory module is arranged to operate as a local cache 302 for the interface 200 such that data retrieved from the network controller 204, is stored within the local cache 302 for subsequent retrieval.

The local cache 302 is controlled by the system controller 202 executing a cache control thread which determines whether the data received from the network controller 204 or disk controller 202 should be stored within the cache 302. The thread may determine this aspect based on the hit rate or latency of the cache 302 and determine the most efficient manner in which to read or write to the cache 302. Subsequently, data retrieved from the storage module 104 may be stored temporarily in the local cache 302 such that subsequent requests for the data need not require the network controller 204 to make a network request.

In this example, the local cache 302 may be implemented using a non-volatile memory module (such as a flash memory module). The local cache 302 may be interfaced to the system controller by a local cache interface 304 which is arranged to transform the physical signals of the system controller 202 into a format suitable for storage within the local cache 302.

By including a local cache 302, the interface 200 is able to reduce the amount of data requests from the network controller 204 for specific pieces of data which are regularly requested. In some instances, such as temporary network failure, the cache 302 can operate as an off line store to eliminate the bandwidth required over the network until bandwidth of the network has been restored.

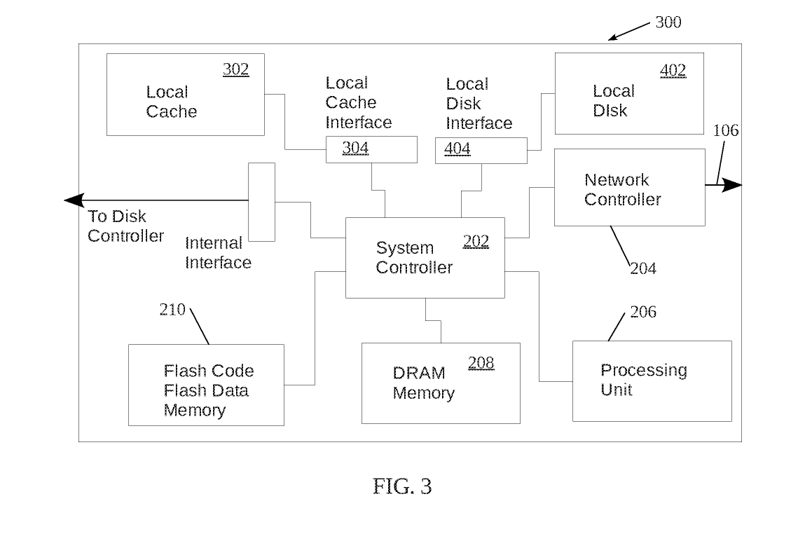

With reference to FIG. 3, there is shown another embodiment of the present invention. In this embodiment, the interface for accessing and manipulating data 300 further includes a local disk cache 402, which in this example is a local hard disk drive. The local hard disk drive is arranged to operate as a local disk cache 402 for the interface 300 such that data retrieved from the network controller 204 may be stored within the local hard disk drive for subsequent retrieval.

The local disk cache 402 may be controlled by the system controller 202 executing a disk cache control thread which determines whether the data received from the network controller 204 or disk controller 118 should be stored within the disk cache 402. The thread may determine this aspect based on the hit rate or latency of the disk cache 402 and determine a most efficient manner to read or write to the disk cache 402. Subsequently, data retrieved from the storage module 104 may be stored temporarily in the local disk cache 402 such that subsequent requests for the data need not require the network controller 204 to make a network request.

In this example, the local disk cache 402 may be implemented by a hard disk drive (such as a SATA hard disk drive of a smaller form factor when compared with the form factor of the hard disk drive which the interface 400 is to replace or a Solid State Drive). The local disk cache 402 may be interfaced to the system controller 202 by a local disk cache 402 interface which is arranged to transform the physical signals of the system controller 202 into a format suitable for storage within the local disk cache 402.

In another example the local disk cache 402 may be implemented by using the driver electronics of a hard disk drive directly, by passing its external interface. In this embodiment the system controller 202 replaces the system controller on a commodity hard disk drive.

By including a local disk cache 402, the interface 300 is able to reduce the amount of data requests from the network controller 204 for specific pieces of data which is regularly requested. In some instances, such as temporary network failure, the cache 402 can operate as an off line store to eliminate the bandwidth required over the network until bandwidth of the network has been restored. As the disk cache 402 also offers a relatively large capacity when compared with the non-volatile memory cache, large files such as multimedia files may be cached within.

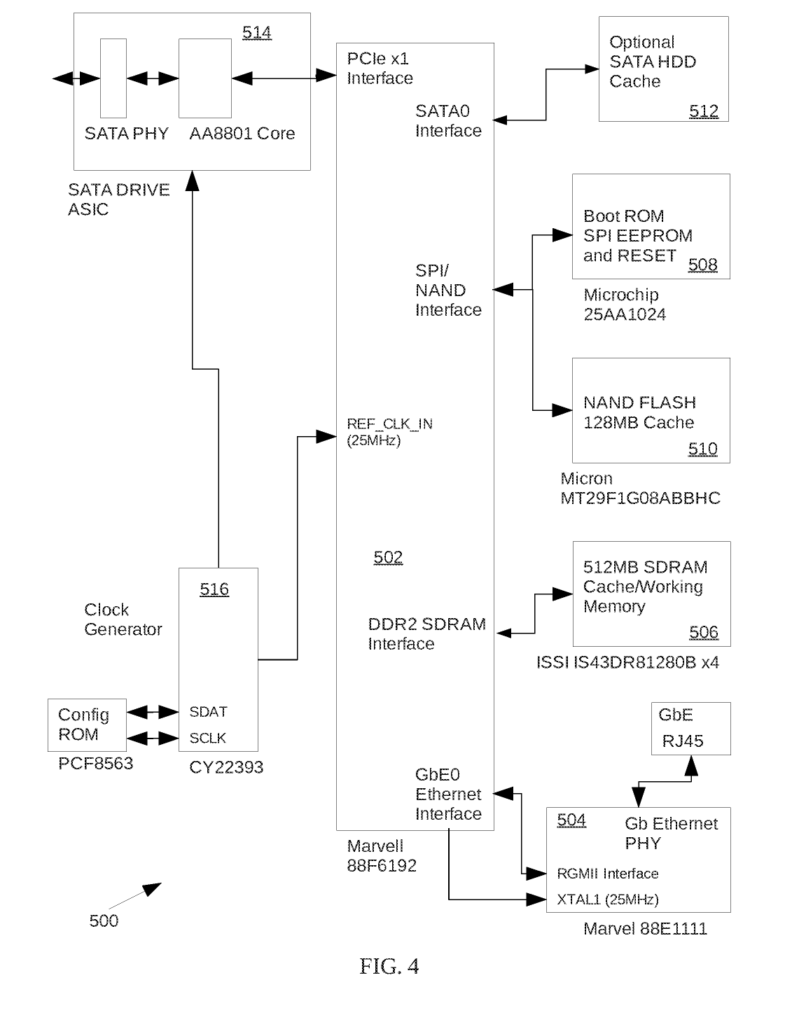

With reference to FIG. 4, there is illustrated the embodiment of the interface 300 shown in FIG. 3 as implemented using one example method of using various Integrated Circuit (IC) components. As the person skilled in the art can appreciate, various alternatives in implementation ranging from the choice of different components to different architectures are possible. The example described herein, is one example method and architecture to implement one embodiment of the present invention. Alternative methods of implementation may include, without limitation, implementing part or all of the logic into a Field Programmable Gate Array (FPGA) or implementing part or all of the logic in one or more Integrated Circuit blocks.

The interface 500 may be implemented to replace a SATA disk drive within a computing device. As such, the following example interface 500 is implemented to communicate with a SATA disk controller found in computing devices such as PCs or Servers. In other examples, the interface 100, 200 and 300 may be implemented to operate with different types of disk controllers such as IDE, SCSI, or flash memory controllers etc by replacing the disk interface components.

In this example, the components may include, without limitation:

1—Marvell 88F6192 or equivalent 502, an IC which acts as the central processing device and functions as a system controller 202 (see for example, http://www.marvell.com/products/processors/embedded/kirkwood/88F 6192-003_ver1.pdf);

2—Marvell 88E1111 or equivalent 504, an IC which acts as the network Physical Layer Transceiver and functions as a network controller 204 (see for example, http://www.marvell.com/products/tranceivers/alaska_gigabit_ether net_transceivers/Alaska_{—}88E1111-002.pdf);

3—ISSI IS43DR81280B or equivalent 506, an IC which acts as a memory module and functions as the working memory 208 to the system controller 202. In some examples, multiple chips may be used to increase the storage capacity of the memory module;

4—Microchip 25AA1024 or equivalent 508, an IC which acts as a ROM unit which may store firmware instructions for the system controller 202 (see for example, http://ww1.microchip.com/downloads/en/DeviceDoc/21836B.pdf);

5—SATA Driver ASIC or equivalent 514, an IC which defines the disk interface which interfaces with a SATA disk controller. This component is discussed in detail with reference to FIG. 7.

This component may also be replaced with an alternative disk interface for other forms of disk controllers to which embodiments of the present invention is to be deployed;

6—CY22393 Clock Generator and PCF8563 Configuration ROM or equivalent 516, these two ICs operate together to define a clock to provide a clock cycle for the operation of the system controller and the disk interface (see for example, http://www.cypress.com/?rID=13746);

7—Micron MT29F1G08ABBHC or equivalent 510, an IC which operates as a NAND Flash unit which functions as the local flash cache (see for example, http://www.micron.com/products/ProductDetails.html? product=products/obsolete/nand_flash/mass_storage//mT29F1G08ABBH C); and,

8—SATA HDD or equivalent 512, a component which is a physical hard disk using the SATA interface. The disk operates as a cache for the present invention.

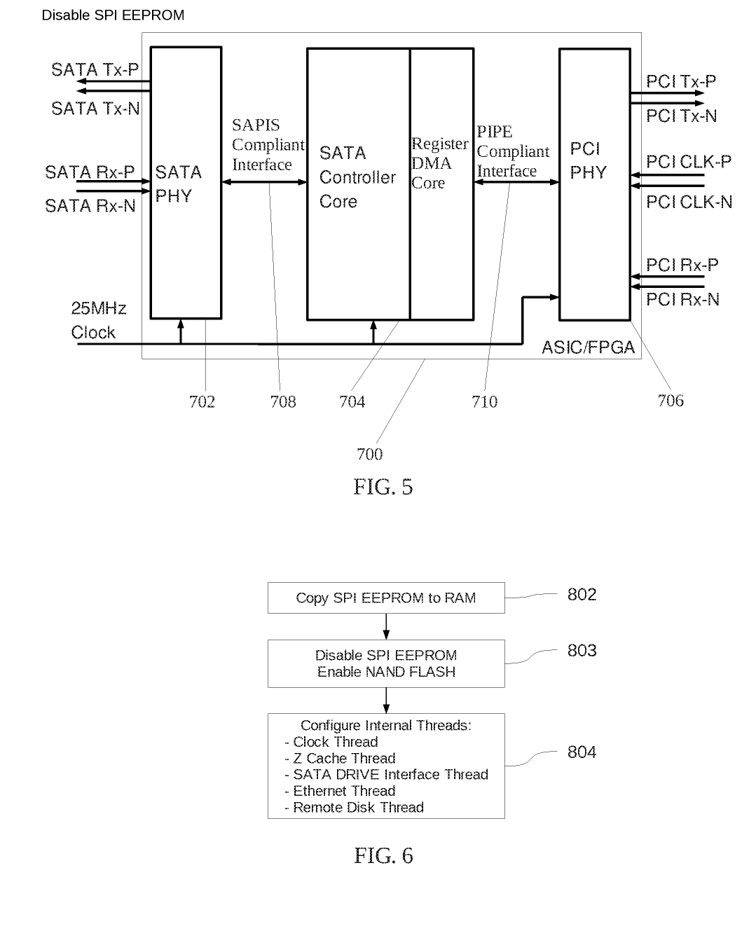

With reference to the block diagram of FIG. 5, the pins of each Integrated Circuit (IC) Component may be connected together on a circuit board or integrated together as a single Integrated Circuit device. An example wiring diagram for each pins of each of these components are as follows:

### Working

### Memory

Marvell 88F6192 ISSI IS43DR81280A
M_CLKOUT→CK
M_CLKOUTn→CK#
M_CKE→CKE
M_RASn→RAS#
M_CASn→CAS#
M_WEn→WE#
M_A[13:0]→A[13:0]
M_BA[2:0]→BA[2:0]
M_DQ[7:0] [symbol] DQ[7:0] on low bytes
M_DQ[15:8] [symbol] DQ[7:0] on high bytes
M_ODT→ODT
M_CS[1:0]→CS# one per bank
M_DQS[1:0]→DQS one per bank
M_DQSn[1:0]→DQS# one per bank
M_DM[1:0]→DM one per bank

### NAND Flash

Marvell 88F6192 MT29F1G08ABBHC
NF_I0[7:0] [symbol] I/0[7:0]
NF_CLE→CLE
NF_ALE→ALE
NF_CEn→CE#
NF_REn→RE#
NF_WEn→WE#
VSS→LOCK
MPP[24]→WP#
MPP[25]→R/B#
MPP[26:28]→CE Selectors for expansion

### SATA Disk Drive

Marvell 88F6192 SATA DRIVE CONNECTOR
SATA_T_P→A+
SATA_T_N→A
SATA_R_N←B
SATA_R_P←B+

### SPI Boot Eeprom

Marvell 88F6192 SPI BOOT EEPROM
SPI_MOSI→MOSI
SPI_MISO←MISO
SPI_SCK→SCK
SPI_CSn→SS
MMP[12]→[Disable]
VCC→HOLD#
VCC→WP#

With reference to FIG. 5, there is illustrated a block diagram of an embodiment of the SATA Driver ASIC 700 (Application Specific Integrated Circuit). In this embodiment, the SATA Driver ASIC 700 is a specific Integrated Circuit (IC) arranged to allow the system controller 202 to communicate with one or more storage modules 104 through the storage interface 118 of the computing or electronic device operating the interface 100, 200 or 500. In one embodiment, the storage interface 118 may be a disk controller which resides on a computer or computing device arranged to connect to the systems bus of the computer or computing device.

In this example, the storage interface 118 is a SATA Disk Controller arranged to control a storage device such as a floppy drive, optical drive, tape drive, hard disk or solid state drives (SSD) or another types of storage devices which uses the SATA computer bus interface for connecting storage devices to the computer bus.

As illustrated in FIG. 5, the SATA Driver ASIC 700 includes the following components:

1—a SATA PHY (Physical Layer Device) 702 which is arranged to connect to the SATA disk controller of the underlying computing or electronic device for converting physical signals of the SATA disk controller to a form suitable for the SATA Controller Core 704;

2—A SATA Controller Core 704, such as the AA8801 Core with a Register/DMA Core arranged to interface with the storage interface 118 which therein is connected to the System Bus 116. The SATA Controller Core 704 in one example is arranged to provide a stream-lined command and data interface with flow control to connect to the storage interface 118; and,

3—A PCIe PHY (Physical Layer Device) 706 which is arranged to facilitate connection between the SATA Drive ASIC 700 with the disk controller 108 and subsequently to the system controller 202 by use of a PCI-Express bus.

As shown in FIG. 5, the SATA PHY 702 may be connected to the SATA Controller Core 704 by use of the SAPIS Compliant Interface 708 defined by Intel Corporation. (http://www.intel.com/technology/serialATA/pdf/sapis.pdf)

As shown in FIG. 5, the SATA Controller Core 704 may be connected to the PCIe PHY 706 by use of the PIPE Compliant Interface 710 defined by Intel Corporation.

(http://download.intel.com/technologv/usb/USB_{—}30_PIPE_{—}10_Final_{—}042309.pdf)

In this embodiment, the SATA Controller ASIC 700 may use a PCI-Express bus to connect and communicate with the Marvell 88F6192 IC 502, which implements at least the functions of the system controller 202. However, in alternative embodiments, the basic architecture of the interface 100, 200, 300 or 500 for accessing and manipulating data may be implemented on a single Integrated Circuit and thereby allowing the SATA Controller ASIC 700 to directly connect with the system controller 202 or through an AHB (Advance High-Performance Bus) Interface without the need to connect the SATA Controller ASIC through a bus.

In other embodiments, the interface for accessing and manipulating data 100, 200, 300 or 500 is implemented for other types of storage interface 118, such as IDE, SCSI disk controllers etc. In these instances, the SATA Controller ASIC 700 may be replaced with alternative controller architecture to facilitate communications between the system controller 202 and the storage interface 118. For example, in the case of an IDE disk controller, the General Purpose Input/Output (GPIO) port interface of the Marvell 88F6192 502 may be used to directly connect to the IDE Controller interface. In the case of a SAS drive controller, a SAS Controller ASIC 700 similar to the example illustrated in FIG. 5 will need to be implemented, but replacing the AA8801 SATA Controller Core with, for example, the CEVA-SAS2.0 Controller Target Core. An example of which is shown at:
http://www.eetindia.co.in/ART 8800592776 1800009_NT_cb49944f.HTM; or,
http://www.epn-online.com/page/new130563/sas-2-0-ip-solution-features-6-0gbit-s-phy-ip.html.

With reference to FIG. 6, there is illustrated a block diagram showing the initialisation processes executed to operate an embodiment of the interface 200, 300, 500 for accessing and manipulating data. In this embodiment, once the underlying computing or electronic device is started, the initialisation process is started by the program counter or BIOS of the computing or electronic device.

The initialisation processes may be implemented as computer software or code which is arranged to be executed by a processing device. In one embodiment, the software may be in the form of a multi-thread real time micro-operating system which is executed by the underlying processing device of the interface 200, 300, 500 in one or more threads capable of communicating and interacting with other threads presently being executed.

In one embodiment, the interface 200, 300, 500 may be divided into individual subsystems which are each initialised and controlled by one or more threads arranged to process software code or modules arranged to interact with one or more individual subsystems. In one example, the subsystems may include:

Z Cache—The Z cache is the cache that preferentially holds “zero” blocks, or blocks that are either close to the beginning of the “drive” or accessed early in the boot cycle. The Z cache may be stored in local flash storage, or on local disk, or both.

RAM Cache—The RAM Cache is a write through cache for recently held blocks. In one example, an adaptive replacement algorithm that uses both size of data chunk and last access time to decide replacement order may be used to control the RAM Cache.

Host Disk Thread—In one example, the host disk thread is responsible for handling requests that come from the underlying computer system and emulates a local disk drive for the underlying computer system which uses the interface 200, 300, 500 for storage.

Clock—The clock is the source of time based operations. It is used to set time outs for various operations and to initiate retries.

Network—The network subsystem interfaces with the remote storage (see below). It may also handle any external packet based requests (pings/DHCP etc.) The network subsystem may also operate as two “halves”, with one being responsible for sending packets (and retrying), and the other being responsible for receiving packets and passing them to the referenced handler.

Remote Disk—The remote disk is the state machine which handles accessing remote storage. In some examples, it may also be responsible for creating the connections to the remote storage, sending requests to the remote disks and dealing with data flows to the remote disks.

In this embodiment, the initialisation process may execute software instructions in the form of software code, machine code or any other type of instructions which controls the interface 200, 300, 500 by initialising and controlling each of these subsystems of the interface 200, 300, 500. To initialise the interface, the system controller begins to access the SPI EEPROM for firmware instructions (at block 802) to start a series of threads (at block 804) which will operate the interface by initialising and controlling each of the subsystems of the interface 200, 300, 500.

In some examples, the firmware instructions may be copied to the working memory of the system controller (at block 802) after which, the SPI EEPROM is disabled whilst enabling the NAND Flash memory (at block 803). Once this is completed, the system threads which control the operation of the interface may be initialised for execution by the system controller (at block 804). These threads include, without limitations:

1—Clock Thread—This thread starts and operates a clock for the system controller 202;

2—Z Cache Thread—This thread starts and operates the local cache 302 for the interface 200, 300, 500;

3—Hard Disk Cache Thread—This thread starts and operates the hard disk cache 402 for the interface 300, 500. In this example, the hard disk is a SATA hard drive. As such a SATA Driver Interface Thread is started and operated. In other examples, alternative threads are started and processed to suit the type of hard drive used for the hard disk cache 402. This thread may be integrated partially, or completely within the Z Cache Thread;

4—Host Disk Interface Thread—This thread is arranged to communicate with a local disk controller to receive and process commands from the local disk controller to access or manipulate data as commanded by the local disk controller.

5—Network Thread—This thread starts and operates the network controller 204 to connect and communicate with a storage module 104 via the communication network 106; and,

6—Remote Disk Thread—This thread starts and operates the processing of the system controller 202 arranged to transform the data received from the network controller 204 into a suitable format for transmission back to the storage interface 118.

Once the interface 200, 300, 500 is initialised, it is ready to receive and process commands from the storage interface 118 to access and/or manipulate data located on a storage module 104 over a communication network 106.

With reference to FIG. 7, there is shown a series of processes which are executed by one embodiment of the Clock thread. In this embodiment, The Clock thread is responsible for house-keeping time based activities. It creates a thread for updating the time (in one embodiment, one hundred updates per second). This thread also handles time-out activities, such as network packet retransmission.

The clock system is a time-out based system. Each request (at block 902) on this subsystem is based on a time to start, a routine to execute and an argument to pass to the routine (at block 906). When the specified time occurs (or has passed in case of delay) the routine will be called with the supplied argument. There is an un-timeout which cancels a time-out request (at block 904).

With reference to FIG. 8, there is shown a flow diagram illustrating the processes executed by one embodiment of the Z cache thread. In this embodiment, The Z cache thread is responsible for managing the local stable caches. There can be one or two local stable caches, either in NAND flash, or locally attached “disk” storage. Both of these storage caches may operate in a similar fashion. The cache may be divided into two sections. The first section of the cache may include an optionally sized section (ALL_CACHE section) which may store data which should always be held in the cache irrespective of usage pattern of the data. The remainder sections of the cache may hold various sized objects that represent areas of the backing storage with data chunks being stored in a “not recently used” pattern.

When a read request (at block 1002) is received from the interface 400, 500, the data requested is either be “not found” in the Z cache, “partially found”, or “fully found” (at block 1004). If no data is found a result of a “not found” signal is returned by the Z cache thread, but if the requested data is found, the data is returned, along with the offset and size of the first data chunk returned.

A write request (at block 1006) will always be stored if it is performed within the first “TIMEOUT” seconds of operation (at block 1008), or if its address is within the ALL_CACHE section. Otherwise the thread may store the data in the cache and update its usage statistics (at block 1010).

When the cache becomes full, the thread must remove data from the Z cache. Data is removed with preference to smaller, infrequently accessed or ancient data. In one embodiment, the thread may remove many smaller chunks of data rather than a single larger chunk from the cache as the time and resource usage of retrieving the larger chunk from the remote storage is higher than the cost of retrieving many smaller chunks remote storage, and thus allowing larger chunks of data to remain in the cache for access.

In a preferred embodiment, the Z cache is a write-aside cache. Writes to the backing store may be handled from the RAM cache. If a crash occurs on recovery, the thread retrieves from the Z cache any outstanding writes that did not complete. These are returned to the RAM cache, and the writes are completed at that time.

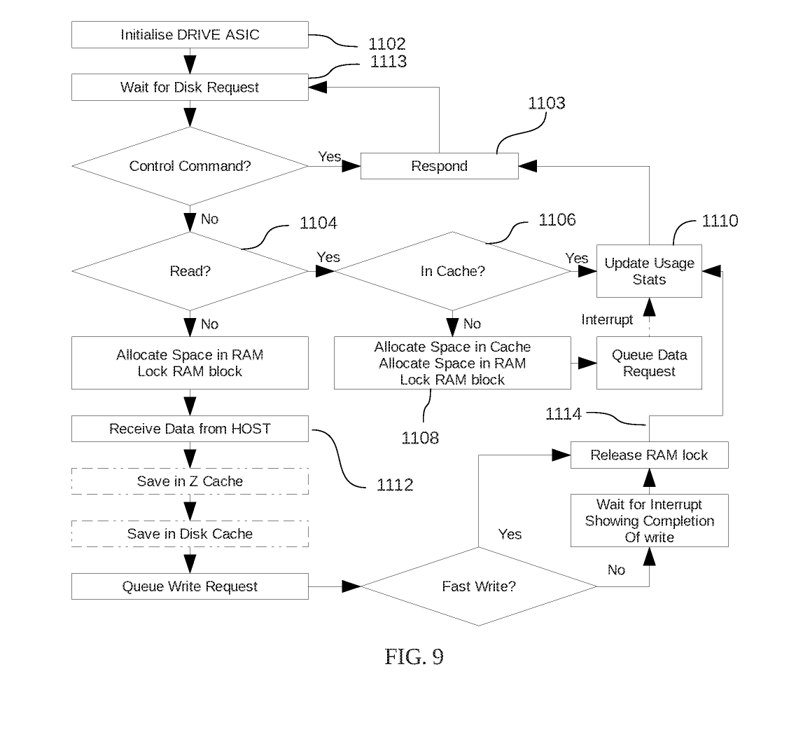

With reference to FIG. 9, there is shown a flow diagram illustrating the processes executed by the host disk interface thread. In this embodiment, the Host Disk Interface thread is arranged to operate with a SATA Drive ASIC, although a similar implementation may be made for alternative forms of disk interface protocols.

The Host Disk Interface thread is responsible for communication with the local disk. In one example, this thread may be created as a pool of worker threads and one supervisor thread. In this example, by having a pool of worker threads, the worker threads may communicate with other subsystems whilst handling requests from the host. Preferably, the number of worker threads in the pool is greater than the number of parallel commands that are allowed (Native Command Queuing (NCQ) for SATA, or tagged command queuing for SCSI).

The supervisor thread waits until it receives a disk request (command packet) from the host (at block 1102). Once the command, and associated data has been received (at block 1113) the command is queued for a worker thread. If one is available it accepts the command immediately, otherwise the command is queued until one thread is available (at block 1104). Since the number of threads should be higher than the number of possible commands this should not happen, unless many status requests are received. The worker thread then performs the request. If it is a “control” command, a command that does not involve storage data transfer, the command is dealt with locally, and the result returned to the host (at block 1103).

If the command is a data read transfer command it involves the local caches (at block 1106) and possibly the remote storage (at block 1108). If the operation is a data write operation we allocate space in the RAM cache for the data write and accept the data from the HOST into the RAM cache (at block 1112). The data is then queued for writing to the Z cache and also for writing to the back end data store. Depending on the operating mode of the cache we return status to the host when one of three goals has been achieved (at block 1114). In Write-Back mode as soon as data is in the RAM cache status can be returned. In Write-Through mode as soon as data is in the Z cache status can be returned, otherwise in Write-Sync mode only when acknowledgement that the data is on the remote storage is status returned.

In one embodiment, if the command is a data read command the thread checks to see if the data is in the RAM cache or the Z cache (at block 1106). If the data is in the RAM cache it is returned to the host immediately. If the data is in the Z cache we allocate space in the RAM cache and queue a request to return the data to the RAM cache. We then suspend this thread until the data has been returned. If the data is not fully returned by the Z cache we retry the operation of any leading or trailing data areas until the data has been fully returned. When the data is in the RAM cache it is then returned to the HOST. If the data is neither in the RAM or Z cache, space is allocated in the RAM cache and a data read request is made on the back end storage system. When the data is in the RAM cache it is returned to the host (at block 1108).

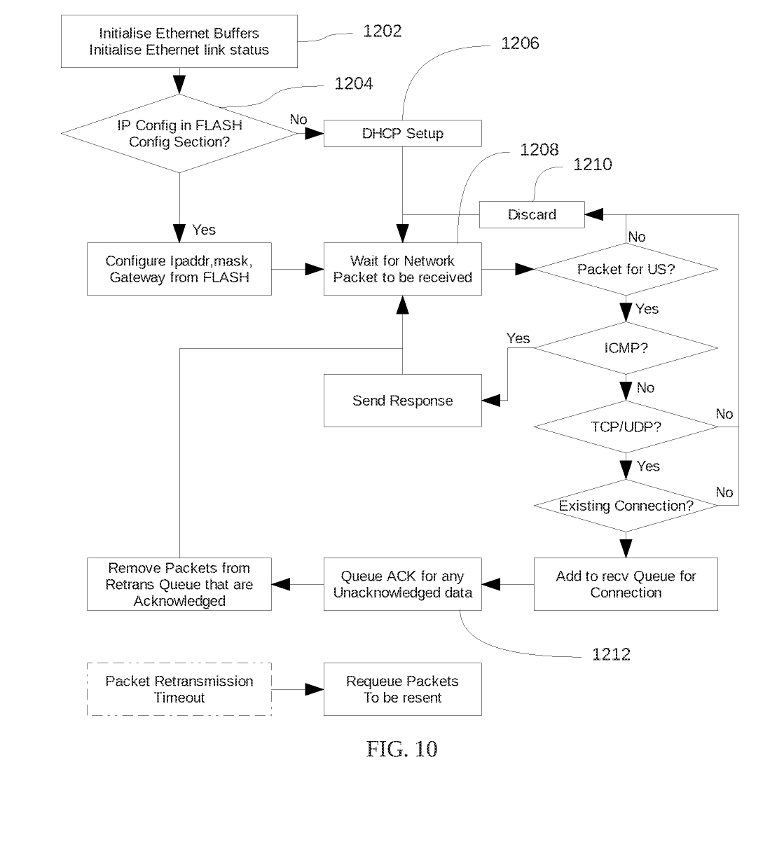

With reference to FIG. 10, there is shown a flow diagram illustrating the processes executed by the network thread. In this embodiment, the network thread handles the initialisation of the physical network interface, and the low level protocol implementation. For an Ethernet network the first task is to initialise the Ethernet controller (at block 1202). Buffers are allocated in RAM, and either an IP address is obtained from the configuration information in FLASH or DHCP is performed to allocate the IP address, mask and gateway (at block 1204).

In one example, the device does not accept incoming connection requests, so all connections are outbound. The thread may respond to ARP requests and local Internet Control Message Protocol (ICMP) echo (ping) requests and possibly, depending on configuration, to remote ICMP echo requests (at block 1206).

The network thread creates a receiver thread (at block 1208) and a sender thread. Also, one thread per Transmission Control Protocol/User Datagram Protocol (TCP/UDP) connection is created. The receiver thread waits for a packet to be received from the network. The packet is inspected to see if it is addressed to us. If it is not the packet is discarded (at block 1210). The packet is then check to see if it is an ICMP packet in which case a response is created and queued to be sent if appropriate. If the packet is for a higher level protocol we queue the packet for the higher level protocol.

For each connection when a packet is received an acknowledgement (ACK) packet is created for any received data and queued for sending (at block 1212). Duplicate data packets are discarded. TCP resend packets that are acknowledged are discarded and the data is extracted and made available to the requester.

When data is requested to be transmitted along a connection an outgoing packet is created, queued to be sent, and then held in case of a retransmission. A time-out with the clock thread is created to enable the retransmission to occur. When the data is acknowledged the time-out is cancelled along with the saved packet being discarded.

In some embodiments, when a new connection is requested to be created a sending thread is created. This thread is responsible for waiting for data that is requested to be sent, encapsulating the data in a network packet for the connection and then queuing the packet to be sent. In these embodiments, when the connection is initially created this thread is responsible for doing the TCP handshake and any initial protocol work, such as performing a Network File System (NFS) mount for an NFS remote store, or a Common Internet File System (CIFS) login for a Server Message Block (SMB) remote store, or the Internet Small Computer System Interface (iSCSI) login for an iSCSI remote store.

In one embodiment, the remote disk threads are created for handling the data reads and writes for the remote storage. The actual operation of this depends on the type of remote storage.

In one example, such as where the type of remote storage is NFS or CIFS storage, the thread implements those protocols. For iSCSI or Fibre Channel (FC) remote storage, the thread creates one or more, SCSI connections to the remote disks and proceeds to send the requests through disk commands. In situations where there may be multiple outstanding requests at a time. Each request is handled by a single thread which blocks during the remote access phase.

In this embodiment, the state machine firstly initialises the connections to the remote storage. In this implementation example, we use iSCSI over Ethernet, but the manner of implementation is similar or identical for other protocols. The state machine may create multiple TCP connections, one to each target in the target group. A thread is created to manage each of the connections, and other threads are created to handle the requests to be sent along each connection. The threads block waiting on requests from the RAM cache. When a request is made the thread builds a data request and starts a transfer request with the remote storage. If there are multiple connections to the same remote storage the connection that is used depends on the weighting policy, either random, round-robin, or address weighted. The remote disk state machine hands packets to the network driver, and waits for a response from the network driver.

When a response has been received the remote disk state machine returns the response to the RAM cache requester and becomes available for another request.

In an alternative embodiment, the interface 100, 200, 300 or 500 may be implemented entirely by a Field Programmable Gate Array (FPGA) or logic device with each of the functions provided by the system controller, network controller and cache to be implemented in software executing on a general purpose computing device capable of operating on a communication network.

In yet another embodiment, the interface 100, 200, 300 or 500 may be implemented into dedicated hardware as a single or multiple integrated circuit devices.

In an alternative embodiment, the local drive interface 404 may be an interface other than the standard, proprietary or published bus interface (such as EIDE, SATA etc). In these embodiments, the local drive interface 404 may be a custom or purposely implemented internal interface arranged to directly connect with the actuator, motor controller or the Read/Write Digital Signal Processor (DSP) found in common Hard Disk drives used in servers, Personal Computers, Laptop Computers, storage arrays or other forms of computing devices.

In another alternative embodiment, the system controller 202, processing unit 205 and internal interface 212 may be similar or identical to those found in common Hard Disk drives used in servers, Personal Computers, Laptop Computers, storage arrays or other forms of computing devices.

In another alternative embodiment, the interface for accessing and manipulating data 100, 200, 300 or 500 may be arranged to operate with a computing device such that the interface for accessing and manipulating data operates as an online backup or restoration tool for the computer device. In one example, the local storage 402 of the interface for accessing and manipulating data 100, 200, 300 or 500 (100-500) may be of a capacity such that operating system and program data can be stored on the local storage 402. In another words, the local storage 402 of the interface 100-500 is arranged to operate as a main storage module for the computer and may store all read/write access data for the computer system, including program files, operating systems and storage files whilst using the network interface and the remote storage device as a supplementary storage device, such as for critical file backup or the like.

In one example of this embodiment, the interface 100-500 may be programmed or implemented to maintain a directory of timestamps for each of the chunks stored on the local storage 402. By maintaining this directory of timestamps, the interface 100-500 may be arranged to check each chunk of the local storage 402 against the corresponding chunk of the remote storage. If the interface 100-500 determines that the chunk of the local storage 402 is newer (which may reflect that the page was written or otherwise modified when the remote storage was off line or disconnected), then the local page of data can be used and copied to the remote storage.

If the page of the local storage 402 is identical to the page of the remote storage, then the page of the local storage 402 is used instead. If the page of the local storage 402 is older than the page in remote storage, then the page of the remote storage can be used instead. In some embodiments a protocol that includes ancillary time stamping information, such as NFS, may be used to communicate to the remote storage'.

In this embodiment it is also possible to have a disconnected operation. In situations where there is no communication possible between the interface and the remote storage for whatever reason, then all data accesses by the computer system may be performed only on the local storage 402 with no connections or requests being made to the remote storage. This is so that unnecessary network transmissions need not be made when it is known that the remote storage is off line. Once communications between the interface 100-500 is restored with the remote storage, then the data on the local storage 402 is merged with the remote storage.

These embodiments are advantageous in that the interface 100-500 may be implemented as a storage module with an added capability to back up data with a remote data source.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

What is claimed is:

1. A system for an interface for accessing and manipulating data to provide access to remote storage with performance enhancements, comprising: a network module arranged to communicate data with a at least one remote storage module via a network; and a system module arranged to communicate with a storage interface to receive data access instructions; and a at least one local cache module to provide cached data based on time, frequency or location of access.

2. The system of claim 1, wherein the network module accesses a virtual disk stored on a at least one remote storage device.

3. The system of claim 2, wherein the system is connected using a physical interface identical to an existing interface.

4. The system of claim 3, wherein the physical dimensions are identical to the dimensions of an existing storage device.

5. The system of claim 2, wherein the cache provides guaranteed storage of three different data areas, each definable in size: the first definable section of the virtual disk, any blocks accessed within the first definable time after the previous initialisation, and any last blocks accessed during the previous operation.

6. The system of claim 5, wherein the network module communicates with a at least one remote storage module only when the data has changed from that stored in the local cache.

7. The system of claim 6, wherein the system includes an interface connected to a at least one local hard disk drive, and utilises a at least one local hard disk drive as the cache device.

8. The system of claim 6, wherein the system includes an interface connected to a at least one non-volatile memory based device, and utilises the at least one non-volatile memory based device as the cache device.

9. The system of claim 6, wherein the system is incorporated into a hard disk drive, and utilises the hard disk drive as the cache device.

10. The system of claim 6, wherein the system is incorporated into a non-volatile memory based device, and utilises the non-volatile memory based device as the cache device.

11. The system of claim 1, wherein the local cache includes a copy of all data stored in the virtual disk at a at least one remote storage module, and meta-data about each block of data.

12. The system of claim 11, wherein the local cache stores data if the network module fails to communicate to the at least one remote storage module, and updates the meta-data to reflect this occurrence.

13. The system of claim 12, wherein the local cache updates a at least one remote storage module when communications is reestablished.

14. The system of claim 11, wherein the data and meta-data in the local cache is used to calculated the difference between the data on the at least one local cache module and the data on a at least one remote storage module on a data manipulation operation.

15. The system of claim 14, wherein the network module communicates with the at least one remote storage module only when a difference is detected between the data on the at least one local cache module and the data on the at least one remote storage module.
